(19) United States
(12) Patent Application Publication
(10) Pub. No.: US 2006/0259599 A1
(43) Pub. Date: Nov. 16, 2006

(54) System and method for providing subject location information

(76) Inventors: Mark H. Verberkt, Eindhoven (NL); Edwin W. M. Hanegraaf, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/541,979

(22) PCT Filed: Jan. 5, 2004
(86) PCT No.: PCT/IB04/00029

§ 371 Date: Mar. 22, 2006

Related U.S. Application Data
(60) Provisional application No. 60/440,295, filed on Jan. 15, 2003.

(51) Int. Cl. G06F 15/173

(52) U.S. Cl. 709/223

(57) ABSTRACT

A system for providing subject location information for use by one or more software applications includes an environmental model (14) storing environmental location information including environment subsections defined by system location co-ordinates. The environmental model communicates with the one or more software applications (12) for receiving an application-specific location request including an area of interest, an application-specific system coordinate resolution and an application-specific update frequency. At least one location sensor (20) senses the position of a subject within the area of interest at a sensor-specific sensing frequency to provide sensor-specific subject location information. A sensor translator (22) translates the sensor-specific subject location information to system location coordinates having the application-specific system coordinate resolution and updates the translated system location coordinates at the application-specific update frequency.

The present invention relates to a method and apparatus for simplifying communications between software applications and a variety of different location sensors. It finds particular application in translating subject location information acquired from a variety of different location sensors with different measurement resolution into location information which is compatible with one or more software applications.

Intelligent home or office environmental systems can provide numerous operations based on the locations of the occupants and electronic devices within the environment. For example, an intelligent remote control device used for operating appliances such as audio and/or video components can automatically adjust to the operational requirements of nearby appliances as the user moves the remote control device around the environment. As another example, a program can follow a person from room to room. Further, intelligent environmental systems can control environmental conditions such as lighting, heating and cooling in a manner which is tailored to the specific desires of the occupant at the occupant's current location as the occupant moves throughout the environment.

These intelligent environment systems typically use software applications which require location information about the occupant and the electronic devices in the environment. The location information is acquired by sensors disposed throughout the environment A wide variety of different types of location sensors may be used to acquire the location information.

Previously, software applications had to communicate with the sensors to receive the location information. However the many different types of location sensors used may each provide location information in forms specific to the particular location sensors, herein referred to as sensor-specific location information.

The position of users and/or devices may be measured in different location coordinates by different sensors, such as inside or outside a particular room versus a position in that room.

A variety of location information from the different location sensors is typically acquired at a wide-range of sensor-specific measurement spatial resolution and frequencies. For example computer vision systems may measure the position of a person 25 times per second, while other sensors may measure irregularly, e.g. as a person leaves or enters a room. Typically, each software application is matched to a specific type of sensor.

Intelligent environmental systems may run many applications simultaneously in the same environment. Direct communications between these applications and the location sensors can require complex interfaces and result in inefficient use of system resources. It is therefore desirable to simplify the communication of location information from location sensors to software applications so that the information from many different types of sensors can be shared efficiently.

According to the present invention, a new and improved system and method for providing subject location information for use by one or more software applications is provided.

In accordance with a first aspect of the invention, the system includes an environmental model for storing environmental location information including environment subsections defined by system location coordinates. The environmental model communicates with the one or more software applications for receiving an application-specific location request including an area of interest and an application-specific system coordinate resolution. The system also includes at least one location sensor for sensing the position of a subject at a sensor-specific sensing frequency to provide sensor-specific subject location information. The system further includes a sensor translator connected to the environmental model and the location sensor for translating the sensor- specific subject location information to system location coordinates having the application-specific system coordinate resolution.

In accordance with another aspect of the invention, the method includes communicating an application-specific location request including an area of interest and an application-specific system coordinate resolution to the environmental model having environmental location information including environmental subsections defined by system location coordinates. The method further includes acquiring sensor-specific subject location information of a subject within the area of interest with at least one location sensor at a sensor-specific sensing frequency. The method also includes translating the sensor-specific subject location information to system location coordinates having the application-specific system coordinate resolution with the sensor translator communicating with an environmental model.

In accordance with yet another aspect of the invention, the acquiring step includes acquiring sensor-specific subject location information with a plurality of location sensors at sensor- specific sensing frequencies of the corresponding application-specific location requests, and the translating step includes translating the sensor-specific subject location information to system location coordinates each having the application-specific system coordinate resolution of the corresponding application-specific location request.

The invention provides the advantage of simplifying the communication of location information obtained from a variety of different location sensors to one or more software applications using an efficient interface of sensor translators. The invention simplifies communication interfaces and reduces system bandwidth and processing power requirements by transferring subject location information to software applications after it has been translated in accordance with application-specific location requests.

It is to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting.

The invention may take form in certain components and structures, preferred embodiments of which will be illustrated in the accompanying drawings wherein:

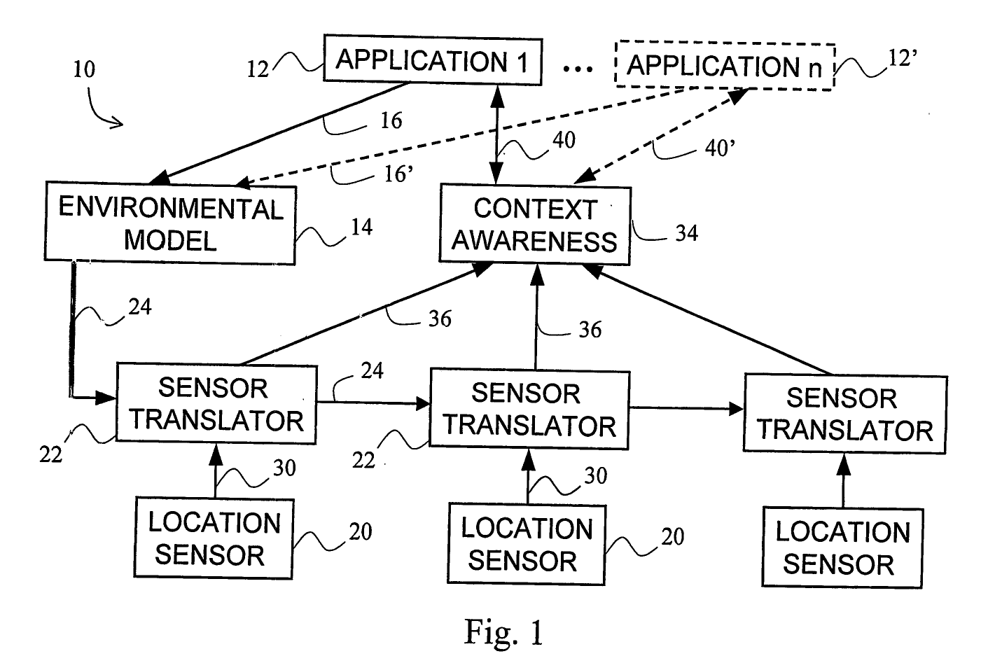

FIG. 1 is a block diagram illustrating the system in accordance with the invention;

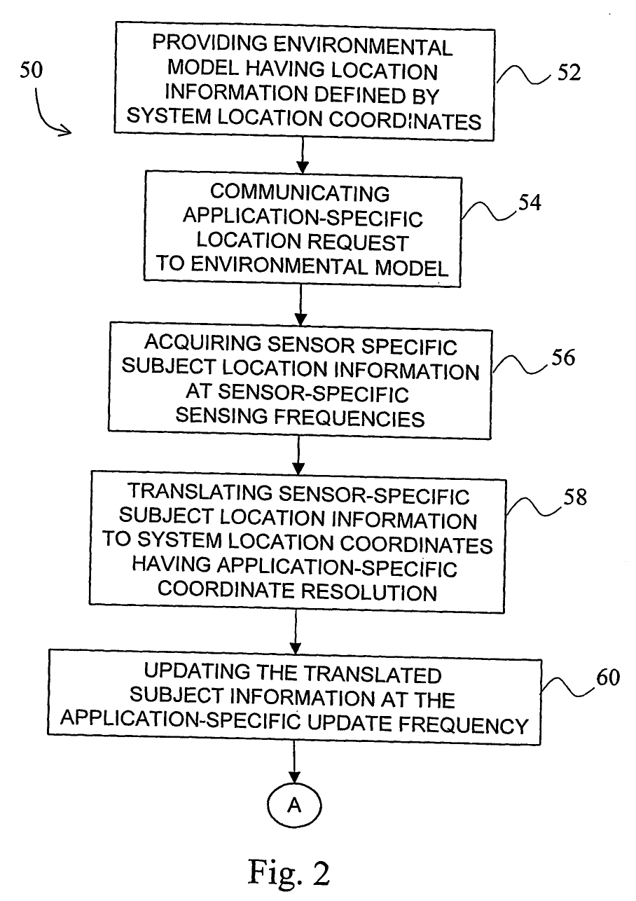

FIG. 2 is a flow diagram illustrating steps of the method in accordance with the invention; and

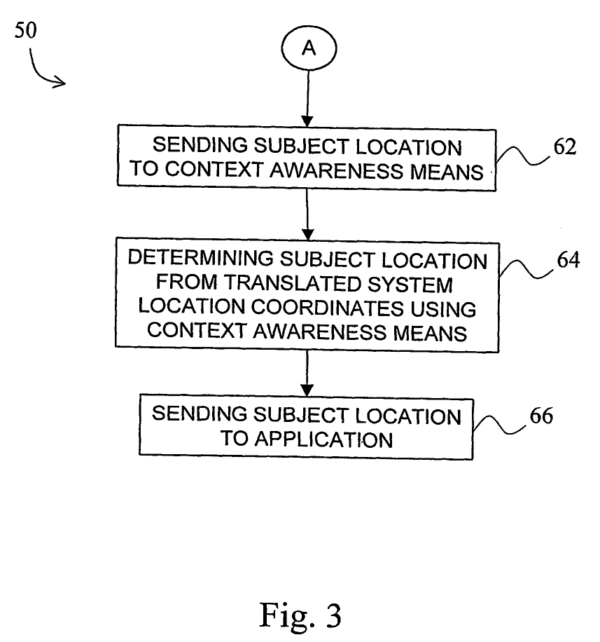

FIG. 3 is a flow diagram illustrating further steps of the method in accordance with the invention.

Referring now to FIG. 1, a system for providing subject location information for use by one or more software applications is shown generally at 10. As used herein, the term “subject” can be used to a person, an animal such as a pet, or an electronic device within the environment.

The system 10 includes one or more software applications 12 for performing any suitable task examples of which are provided below, requiring subject location information. Each application 12 can be written using any suitable computer programming language and adapted for running on any suitable known computer (not shown). In systems running a plurality of applications 12-12′, the applications may run simultaneously. For simplicity of explanation, the construction and operation of the system 10 is described with reference to a single application 12 unless noted otherwise.

The system 10 further includes an environmental model 14 defining the environment using universal system spatial coordinates. The environmental model 14 models the structure of the environment and includes information such as the location of rooms, the locations of the walls forming the rooms, the location of hallways interconnecting the rooms, and the locations of doors and windows of the rooms or the building. The environmental model can also include location information of electronic devices within the environment defined by the system coordinates.

The environmental model preferably includes environment subsections, each defined by the system coordinates. Examples of subsections include, but are not limited to, rooms or hallways in a building, locations outside the building. The subsections can also include regions of a living space or office space, the regions being groups of rooms or areas within a single room, or room spaces divided by partial or virtual partitions.

A portion of the information contained within the environmental model includes static information which is loaded into the model upon system startup. Examples of static information include, but are not limited to, the spatial coordinate location and interrelation of the location of the walls defining the rooms and hallways, and the location of electronic devices.

The application 12 is connected to the environmental model 14 in any suitable known manner 16 for communicating location requests to the environmental model. The location requests include the area of interest for which the application wants to receive location information and are thus called application-specific location requests. The environmental model is adapted according to application specific location requests. In this way, the environmental model is a structure in which the requirements of all applications are gathered in a uniform way.

The application-specific location request also includes the coordinate resolution used by the application to locate the subject in the area of interest. The coordinate resolution is defined using the system coordinates and is referred to as the application-specific system coordinate resolution. For example, if the application 12 needs to know whether a person or device has entered a specific area in the kitchen, the application communicates an application-specific location request to the environmental model 14 which includes system coordinates of sufficient resolution to define the specific area of the kitchen. The application-specific location requests are dynamic because the area of interest and the coordinate resolution can change during the operation of the application 12.

The system 10 also includes a plurality of location sensors 20 disposed throughout the environment. A variety of different types of location sensors are typically used simultaneously. Examples of location sensors 20 include, but are not limited to, a computer vision apparatus, a motion sensor, a radio transponder, door or widow switches indicating whether the door or window is opened or closed, doorway sensors that indicate if someone has moved through the doorway, touch sensors on equipment that indicate that the piece of equipment had been touched, or any other suitable known sensors for sensing position information of a subject.

The subject location information provided by the different location sensors is defined by a variety of different location coordinate systems each being specific to the particular sensor, e.g., x,y coordinates within the overall environment, x,y coordinate positions within a room, presence anywhere in a room or region crossing a threshold, and the Alike. Furthermore, the variety of different location sensors 20 typically acquire the location information at a variety of different sampling frequencies, hereinafter referred to as sensor-specific sensing frequencies. For example, a computer vision apparatus may acquire location information 25 times or more each second; whereas a motion detector may acquire location information 2 to 5 times each second. A touch sensitive detector or a threshold detector may acquire information irregularly. Accordingly, the subject location information provided by the different location sensors 20 is referred to as sensor- specific subject location information.

In order to make the wide variety of location information acquired at different sensing frequencies available for use by the one or more applications 12, the system 10 also includes a sensor translator 22 communicating with the environmental model 14 at 24 and communicating with the location sensor 20 at 30. The sensor translator 22 uses the application-specific location request and the environmental model defined by the system coordinates to translate the sensor- specific subject location information to system location coordinates having the appropriate application-specific system coordinate resolution. That is, the sensor translator uses the environmental model as a translation key to translate the output of the sensor to the input format required by the application. The adapting of the environmental model with the application-specific location request is used by the sensor translators to filter the information. In this manner, the sensor translator 22 provides the subject location information in system coordinates and provides the system coordinates at a suitable coordinate resolution most appropriate to needs of the application 12.

The application-specific location request can also include an application-specific update frequency providing the frequency at which the translated system location coordinates should be updated. The sensor translator 22 receives the application-specific update frequency from the environmental model 12 and updates the location information acquired by the location sensor 20 in accordance with the update frequency. In this manner, the translated location information provided by the sensor translator 22 is updated appropriately in accordance with the needs of the application thereby making the most efficient use of the available communication bandwidth and processing power. For example, a computer video apparatus can be used to acquire subject location information at a native sensing frequency of 25 times per second. However, the application 12 may only require that the location information to be updated 2 times per second. In order to provide the most efficient use of system resources, the sensor translator 22 updates the location information translated into system location coordinates at the application-specific update frequency of 2 times per second.

The system 10 also includes a context awareness subsystem 34 connected to the sensor translator 22 at 36 for receiving the translated subject location system coordinates. The context awareness application 34 collects several pieces of translated subject location information from several different location sensors 20 and uses logic methods to determine the location of the subject. For example, the context awareness subsystem may receive location information indicating that a person is using an electronic device from one sensor and that the device is located at a specific position from another sensor to conclude that the person is located the position of the electronic device. As another example, a specific person is identified by computer vision as being in a room. From a threshold crossing indicator that indicates someone entered or left that room and a motion detector in an adjoining, the content awareness can infer that the identified person is now in the adjoining room. The context awareness subsystem 34 communicates with the application 12 at 40 to provide the subject location information to the application. The context awareness subsystem also has (individual) application requirements in order to identify which inferred location information should be sent to the application.

Referring now to FIGS. 2 and 3, a method for providing subject location information from a plurality of location sensors to one or more software applications, shown generally at 50, is described.

The method includes providing an environmental model having location information defined by system location coordinates at 52. The environmental location information preferably includes environmental subsections defined by the system location coordinates as described above.

The method further includes communicating one or more application-specific location requests to the environmental model at 54. The application-specific location request includes an area of interest, an application-specific system coordinate resolution, and potentially an application-specific update frequency as described above.

The method further includes acquiring sensor specific subject location information within the area of interest at sensor-specific sensing frequencies at 56 as described above. The method also includes translating the sensor-specific location information to system location coordinates having application-specific coordinate resolutions at 58 as described above. The method further including the step of updating the translated system location coordinates at the application-specific update frequency at 60.

The method further includes sending subject location to context awareness means at 62 and determining the subject location from the translated system location coordinates using the context awareness means at 64. The method also includes sending the subject location to the application at 66.

The invention has been described with reference to preferred embodiments. Obviously, modifications and alterations will occur to others upon reading and understanding the preceding specification. It is intended that the invention be construed as including all such modifications and alterations insofar as they come within the scope of the appended claims or the equivalents thereof.

1. A system for providing subject location information for use by one or more software applications (12), the system comprising:
an environmental model (14) which stores environmental location information including environment subsections defined by system location coordinates, said environmental model (14) communicating with the one or more software applications (12) for receiving an application- specific location request including an area of interest with an application-specific system coordinate resolution;
at least one location sensor (20) for sensing the position of a subject within the area of interest at a sensor-specific sensing frequency and resolution to provide sensor-specific subject location information; and
a sensor translator (22) connected to the environmental model (14) and the location sensor (20) for translating the sensor-specific subject location information to system location coordinates having the application-specific system coordinate resolution.

2. The system defined in claim 1 wherein the application-specific location request further includes an application-specific update frequency and the sensor translator (22) updates the translated system location coordinates at the application-specific update frequency.

3. The system defined in claim 2 further including:
a plurality of location sensors (20), the environmental model (14) receiving a plurality of application-specific location requests each including at least one of an area of interest, an application-specific system coordinate resolution, and an application-specific update frequency for the translation of subject location information from said plurality of location sensors (20).

4. The system defined in claim 1 wherein the environmental model is adapted in accordance with each application-specific location request.

5. The system defined in claim 1 further including:
a context awareness subsystem (34) which determines the subject location from the translated location coordinates.

6. The system defined in claim 1 wherein the environmental subsections includes one of:
rooms within a building;
hallways within a building;
locations outside a building;
regions of a living space; and
regions of an office building.

7. The system defined in claim 1 wherein the location sensor (20) includes one of:
computer vision apparatus;
a touch sensor;
a threshold crossing detector;
a motion detector; and
a radio frequency transponder.

8. A system for providing subject location information for use by one or more software applications comprising:
environmental model means (14) for communicating with the one or more software applications for receiving an application-specific location request including an area of interest and an application-specific system coordinate resolution, said environmental model means modeling environmental location information including environment subsections defined by system location coordinates;
location sensing means (20) for sensing the position of a subject within the area of interest at a sensor-specific sensing frequency to provide sensor-specific subject location information; and
sensor translating means (22) connected to the environmental model means and the location sensing means (20) for translating the sensor-specific subject location information to system location coordinates having the application-specific system coordinate resolution.

9. The system defined in claim 8 wherein the application-specific location request further includes an application-specific update frequency and the sensor translating means (22) updates the translated system location coordinates at the application-specific update frequency.

10. The system defined in claim 8 wherein the environmental model is adapted in accordance with the application-specific location request.

11. The system defined in claim 8 further including:
context awareness means (34) for determining the subject location from the translated location coordinates.

12. The system defined in claim 8 wherein the location sensing means (20) includes one of a computer vision apparatus, touch sensor, a threshold crossing detector, a motion detector, and a radio frequency transponder.

13. The system defined in claim 8 wherein the environmental subsections are one of rooms within a building, hallways within a building, locations outside a building, regions of a living space and regions of an office building.

14. The system defined in claim 8 wherein the subject is one of a person, an animal, and an electronic device.

15. A method of providing subject location information from a plurality of location sensors to one or more software applications comprising:
communicating an application-specific location request including an area of interest and an application-specific system coordinate resolution to the environmental model having environmental location information including environmental subsections defined by system location coordinates;
acquiring sensor-specific subject location information of a subject within the area of interest with at least one location sensor at a sensor-specific sensing frequency; and
translating the sensor-specific subject location information to system location coordinates having the application-specific system coordinate resolution using the environmental model as a translation key.

16. The method defined in claim 15, further including:
communicating a plurality of application-specific location requests to the environmental model, each request corresponding to the same software application.

17. The method defined in claim 15, further including:
communicating a plurality of application-specific location requests to the environmental model corresponding to different software application.

18. The method defined in claim 17 wherein the environmental model adapts in accordance with the application-specific location requests corresponding to different software applications.

19. The method defined in claim 15 wherein the acquiring step includes:
acquiring sensor-specific subject location information with a plurality of location sensors at sensor-specific sensing frequencies of the corresponding application-specific location requests; and
the translating step includes:
translating the sensor-specific subject location information to system location coordinates each having the application-specific system coordinate resolution of the corresponding application- specific location request.

20. The method defined in claim 15 wherein the communicating step includes:
the application dynamically communicating the application-specific location request to the environmental model.

21. The method defined in claim 15 wherein the application-specific location request includes an application-specific update frequency, and further including:
updating the translated system location coordinates at the application-specific update frequency.

22. The method defined in claim 15 further including:
determining the subject location from the received translated system location coordinates.

23. The method defined in claim 15 wherein the subject is at least one of:
a person;
an animal; and
an electronic device.
